(19) United States
(12) Patent Application Publication
(10) Pub. No.: US 2024/0411028 A1
(43) Pub. Date: Dec. 12, 2024

(54) Adaptive Wireless Transmitter Power Control for Global Navigation and Satellite System (GNSS) Interference Mitigation

(71) Applicant: Google LLC, Mountain View, CA (US)

(72) Inventors: Jing Liang, Saratoga, CA (US); Jibing Wang, San Jose, CA (US); Robert S. Trocke, Racine, WI (US); Li-Chung Tung, Taipei City (TW); Jie Song, Fremont, CA (US); Wyatt Riley, Wayne, PA (US); TsungYang Wu, New Taipei City (TW); Yu Lin Shiao, Taipei City (TW)

(73) Assignee: Google LLC, Mountain View, CA (US)

(21) Appl. No.: 18/691,739

(22) PCT Filed: Apr. 1, 2022
(86) PCT No.: PCT/US2022/071513

§ 371 Date: Mar. 13, 2024

Related U.S. Application Data
(60) Provisional application No. 63/244,143, filed on Sep. 14, 2021.

(51) Int. Cl. G01S 19/21

(52) U.S. Cl. CPC G01S 19/21

(57) ABSTRACT

This document describes techniques, apparatuses, and systems for adaptive wireless transmitter power control for GNSS interference mitigation. This document addresses interference degradation in GNSS operations of computing devices due to integration of a variety of radio interference aggressors in the same platform. A GNSS subsystem is disclosed that may assert power back-off requests to reduce the power of one or more RAT transmitters and limit signal degradation during GNSS subsystem operations. Qualities of the satellite signals received at the GNSS subsystem may be analyzed to determine if it is appropriate to assert or deassert the power back-off requests. In this way, the described techniques, apparatuses, and systems for adaptive wireless transmitter power control for GNSS subsystems may adaptively manage GNSS subsystem operations and other RATs to reduce GNSS signal degradation due to interference.

### BACKGROUND

Modern computing devices often include multiple subsystems, such as a global navigation satellite system (GNSS) subsystem, that enable the performance of multiple functions. To support multiple functions, many devices include multiple radio access technology (RAT) transmitters that may act as radio interference aggressors when integrated in the same device. As different wireless technologies (e.g., Fifth-Generation New Radio (5G NR) and Ultra-Wide Band (UWB) technologies) are developed and integrated into ever-smaller devices, interference mitigation across multiple RAT transmitters may become increasingly difficult.

### SUMMARY

This document describes techniques, apparatuses, and systems for adaptive wireless transmitter power control for GNSS interference mitigation. This document addresses interference degradation in GNSS operations of computing devices due to the integration of a variety of radio interference aggressors in the same device. A GNSS subsystem is disclosed that may assert power back-off requests to reduce the power of one or more RAT transmitters and limit signal degradation during GNSS operations. Qualities of the satellite signals received at the GNSS receiver may be analyzed to determine if it is appropriate to assert or deassert the power back-off requests. In this way, the described techniques, apparatuses, and systems for adaptive wireless transmitter power control for GNSS subsystems may adaptively manage GNSS operations and the operations of RATs to reduce GNSS signal degradation due to interference.

In more detail, this document describes a comprehensive GNSS-state-based wireless transmitting-power-level back-off system, which can be implemented in smartphones, wearable devices, and any other devices with coexistence concerns from radio transmitter interferences to GNSS sub-systems. A method is described that includes determining a set of satellite signal qualities for a set of satellite signals received at a GNSS receiver operating on a computing device. Based on the set of satellite signal qualities, it may be determined that the set of satellite signal qualities does not satisfy a signal quality threshold, and a power back-off request may be asserted that is effective to reduce a power of one or more RAT transmitters operating on the computing device.

In another method, a power back-off request is asserted that is effective to reduce power of at least one RAT transmitter operating on the computing device. If determined that a tracking operation of a GNSS subsystem has been requested, it may be determined that deasserting the power back-off request during the tracking operation is appropriate. In response to determining that deasserting the power back-off request during the tracking operation is appropriate, deasserting the power back-off request for one or more RAT transmitters of the at least one RAT transmitter effective to reduce power restrictions for the one or more RAT transmitter.

A system is also described that includes a GNSS subsystem, at least one RAT transmitter, at least one processor, and one or more non-transitory computer-readable storage media that, when executed by the at least one processor, cause the at least one processor to perform one or more aspect of adaptive wireless transmitter power control for GNSS interference mitigation. In an aspect, the system is configured to assert an initial power back-off request effective to reduce a transmit power of the at least one RAT transmitter operating on the computing device. The system may then determine that a tracking operation of the GNSS has been requested and determine whether a power back-off request is appropriate during the tracking operation. If it is determined that the power back-off request is appropriate during the tracking operation, the power back-off request may be asserted effective to reduce the power for the at least one RAT transmitter.

This Summary is provided to introduce simplified concepts for adaptive wireless transmitter power control for GNSS interference mitigation, which are further described below in the Detailed Description and are illustrated in the Drawings. This Summary is not intended to identify essential features of the claimed subject matter, nor is it intended for use in determining the scope of the claimed subject matter.

### BRIEF DESCRIPTION OF THE DRAWINGS

The details of one or more aspects for adaptive wireless transmitter power control for GNSS interference mitigation are described in this document with reference to the following drawings:

FIG. 1 illustrates an example operating environment of a GNSS subsystem;

FIG. 2 illustrates an example computing device capable of implementing adaptive wireless transmitter power control for GNSS interference mitigation;

FIG. 3 illustrates an example timing diagram for GNSS duty-cycle tracking;

FIG. 4 illustrates an example of a signal quality determinations in accordance with one or more aspects of adaptive wireless transmitter power control for GNSS interference mitigation;

FIG. 5 illustrates an example method for performing one or more aspect of adaptive wireless transmitter power control for GNSS interference mitigation;

FIG. 6 illustrates an example method for asserting power back-off requests in an acquisition state in accordance with one or more aspects of adaptive wireless transmitter power control for GNSS interference mitigation;

FIG. 7 illustrates an example method for asserting/deasserting power back-off requests in a tracking mode in accordance with one or more aspects of adaptive wireless transmitter power control for GNSS interference mitigation;

FIG. 8 illustrates an example method for implementing a RAT in accordance with one or more aspects of adaptive wireless transmitter power control for GNSS interference mitigation;

FIG. 9 illustrates an example method for asserting a power back-off request based on signal quality; and

FIG. 10 illustrates an example method for deasserting a power back-off request in accordance with one or more aspects of adaptive wireless transmitter power control for GNSS interference mitigation.

The use of same numbers in different instances may indicate similar features or components.

### DETAILED DESCRIPTION

### Overview

Modern computing devices are required to support multiple functions to accommodate the fluid nature in which people interact with their devices. Moreover, the compactness of portable computing devices has continued to become more important to enable users to easily transport and access their portable devices. To support the multi-functionality while satisfying compactness constraints, devices often integrate multiple RAT transmitters within a single platform to support various RAT subsystems. Due to simultaneous operation of these transmitters, signals received at one subsystem may be interfered with by signals and noise generated from other RAT transmitters. One such example of this is in GNSS subsystem(s) that utilize satellite signals to determine position and/or time solutions. If other RAT technologies utilize the same or adjacent radio frequency bands that are used for GNSS operations to perform non-GNSS operations, satellite signals relied upon for GNSS operations may experience degradation from radio frequency interference.

With the creation of advanced wireless technologies (e.g. 5G (Fifth-Generation) and Ultra-Wide Band (UWB) technologies) that enable a wider variety of bands to be used in signal transmission, this problem becomes more prevalent and more difficult to mitigate. This document describes techniques, apparatuses, and systems for adaptive wireless transmitter power control for GNSS interference mitigation. The techniques, apparatuses, and systems may use a comprehensive GNSS-state-based wireless transmitting-power-level back-off system, which can be implemented in smartphones, wearable devices, and any other portable devices with coexistence concerns from radio transmitter interferences to GNSS sub-systems.

In some implementations, adaptive wireless transmitter power control for GNSS interference mitigation is used to determine when parasitic interferences are prevalent during GNSS operations. As such, power back-off requests may be utilized only when necessary to ensure proper operation of the GNSS, so that RAT subsystems may not experience unnecessary interruption. In aspects, the GNSS may implement adaptive wireless transmitter power control for GNSS interference mitigation on a per-constellation or per-band basis. In this way, power back-off requests may be used to reduce transmitter interference in specific channels where signal degradation is the most prevalent, while other transmitters that utilize non-obstructing channels may operate unimpeded.

Adaptive wireless transmitter power control for GNSS interference mitigation may be state-based such that other RAT subsystems are only interrupted during active operation of the GNSS. Specifically, when the GNSS performs duty cycle tracking, the power back-off requests may be deasserted when the GNSS is in the idle state. Through this approach, power back-off requests may be adaptively controlled based on the characteristics of each GNSS operation. Thus, adaptive wireless transmitter power control for GNSS interference mitigation, as described herein, may ensure optimum performance in GNSSs with limited reduction in other RAT subsystem performance.

### Example Operating Environment

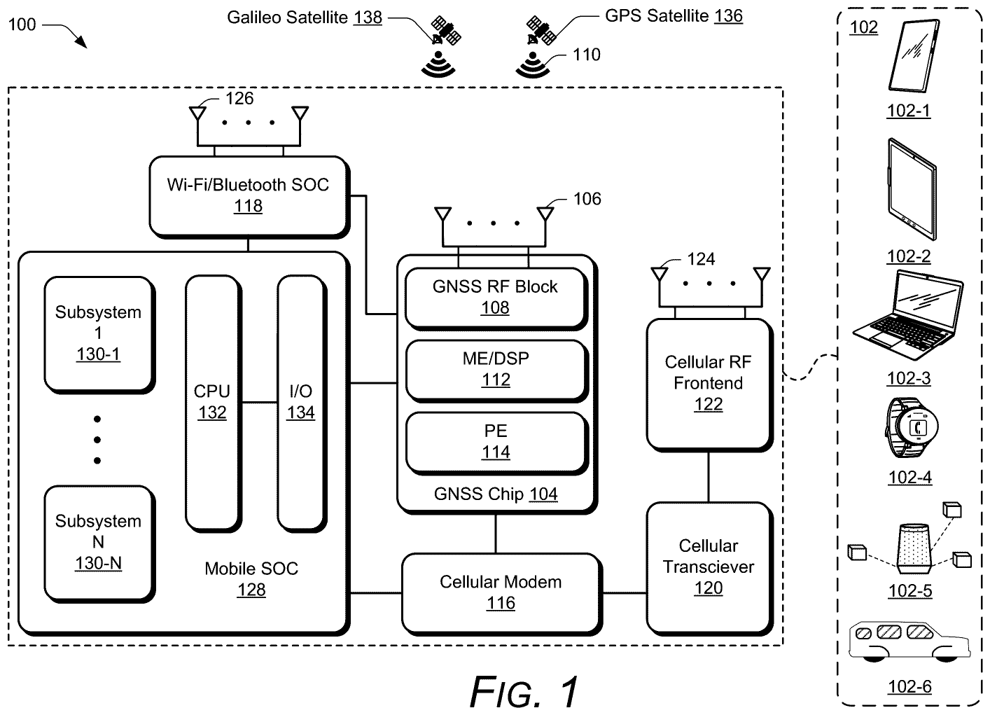

FIG. 1 illustrates an example operating environment 100 of a GNSS. As illustrated, the example operating environment 100 includes a computing device 102 that implements a GNSS subsystem. The computing device 102 may be implemented as any suitable device, some of which are illustrated as a smart-phone 102-1, a tablet computer 102-2, a laptop computer 102-3, a wearable computing device 102-4 (e.g., smart-watch), a home automation device 102-5, or a vehicle computing system 102-6. Although not shown, the computing device 102 may also be implemented as any of a mobile station (e.g., fixed-or mobile-STA), a mobile communication device, a client device, a user equipment, a mobile phone, an entertainment device, a mobile gaming console, a personal media device, a media playback device, a health monitoring device, a drone, an IoT device, and/or other types devices of that implement multiple RAT subsystems. In some implementations, the computing device 102 may be a mobile computing device that implements a GNSS and at least one non-GNSS RAT subsystem within a single platform.

In FIG. 1, the GNSS subsystem is implemented in the GNSS chip 104, which may be an individual system-on-chip (SoC) or an integrated intellectual property (IP) block within a modem or other SoC. The GNSS chip 104 may include a receiver that communicatively couples to one or more antennas 106 through the GNSS radio-frequency (RF) block 108 to receive GNSS signals over a connection 110. The antennas 106 may include an array of multiple antennas that are configured similarly to or differently from one another. The GNSS chip 104 may also include Radio Frequency Front-End (RFFE), such as Low-Noise Amplifiers (LNA) and Band-Pass Filters (BPF). The GNSS RF block 108 may include various elements such as a phase-lock-loop (PLL) or local oscillator (LO). Although not illustrated, the GNSS chip 104 may implement a down-converter or analog-to-digital converter (ADC). The GNSS chip 104 may implement a measurement engine (ME) and digital signal processing unit (DSP) 112 to measure, filter, or compress signals received by the antennas 106. The GNSS chip 104 may additionally include a position engine 114 to determine position solutions from the signals received by the antennas 106.

The computing device 102 may include any number of other RAT subsystems that interface with the GNSS chip 104. For example, the computing device 102 may include a cellular modem 116 or a Wi-Fi/Bluetooth SoC 118 that interfaces with the GNSS chip 104. Though illustrated as individual SoCs, it should be noted that any of the components of the computing device 102, including the GNSS chip 104, the cellular modem 116, or the Wi-Fi/Bluetooth SoC 118, may be implemented in conjunction with or separate from any other component of the computing device 102.

The cellular modem 116 may utilize a cellular transceiver 120 that couples to the cellular RF frontend 122 to transmit and receive wireless communications through one or more antennas 124. The cellular transceiver 120 may be utilized to transmit and receive communications requests. The cellular RF frontend 122 or the cellular transceiver 120 may include any number of components, as described with respect to the GNSS chip 104. In some implementations, the one or more of the antennas 124 may be shared with any other RAT subsystem. For example, the antennas 124 may be utilized by the GNSS chip 104 or the Wi-Fi/Bluetooth SoC 118.

The Wi-Fi/Bluetooth SoC 118 may communicate data across a number of wireless access technologies (e.g. wireless local area network (WLAN) or personal area network (PAN)). The Wi-Fi/Bluetooth SoC 118 may communicate using one or more antennas 126. Like the antennas 124, the antennas 126 may be shared among any of the multiple RAT subsystems or GNSS subsystems. Although not illustrated, the computing device 102 may include any other RAT subsystem that communicates over any appropriate wireless communication protocol (e.g., IEEE 802.15.4, Wi-Fi®, UWB, ZigBee®, 6LOWPAN®, Thread®, Z-Wave®, Bluetooth® Smart, ISA100.11a™, WirelessHART®, MiWi™, and so on). In some implementations, one or more RAT subsystem may communicate in accordance with at least one cellular wireless technology, for example, Long Term Evolution (LTE) or 5G NR technologies.

The computing device 102 may also include a mobile SoC 128 that implements various functions and applications of the computing device 102. The mobile SoC 128 may include various subsystems 130 (e.g., subsystem 130-1 through subsystem 130-N) that enable various functions of the computing device 102. The mobile SoC 128 may include any number of applications (e.g., navigation applications, messaging applications, internet access applications, etc.) that execute on the computing device 102. Any of the applications may initiate requests to any other portion of the computing device 102. For example, location requests may be asserted to the GNSS subsystem, communication requests may be asserted to the cellular subsystem, or internet/device connectivity requests may be asserted to the Wi-Fi/Bluetooth subsystem. The applications or subsystems of the computing device 102, including any of the RAT subsystems (e.g. GNSS chip 104, cellular modem 116, or Wi-Fi/Bluetooth SoC 118), may be executed by a central processing unit 132 (CPU 132) of the mobile SoC 128. Alternatively, any of the RAT subsystems or any other portion of the computing device 102 may include a processor that performs the operations of that subsystem. Although not shown, the CPU 132 may execute an operating system (OS) that provides various functionality to a user of the computing device 102.

The CPU 132 may execute any of the various systems of the computing device 102 through the input/output (I/O) connections 134. For example, the I/O connections 134 may be used to transfer data between any of the RAT subsystems and the CPU 132 via a data bus. The I/O connections 134 of the computing device 102 may include universal serial bus (USB) ports, coaxial cable ports, and other serial or parallel connectors (including internal connectors) useful to couple the mobile SoC 128, or the computing device 102 generally, to various components, peripherals, or accessories.

Any of the RAT subsystems may communicate with one or more base stations. The GNSS subsystems may communicate with one or more satellites (e.g., Global Positioning System (GPS) satellite 136 Galileo satellite 138). With respect to GNSS subsystems, GNSS operations (e.g., position/time solutions) can be determined using a single-band receiver (e.g., L1, centered at 1575.42 megahertz (MHz)), or multi-band receivers (e.g., L2, centered at 1227.60 MHz; L5, centered at 1176.45 MHZ). In some implementations, GNSS operations may utilize any number of constellations (e.g, GPS, Galileo, GLONASS, Beidou, Quazi-Zeneth Satellite System (QZSS), NaviC) or bands (e.g., L1, L5, L2, and so on). With the close placement of GNSS and other wireless RAT transmitters, or in some cases antenna sharing, unwanted interferences and noise could be coupled to the antennas and associated RF blocks when these transmitters are operating. To mitigate the interferences from these wireless RATs and guarantee proper operation of the GNSS subsystem, the GNSS subsystem may assert power back-off requests to any other RAT subsystem through the various interfaces. In this way, adaptive wireless transmitter power control for GNSS interference mitigation may optimally enable multiple RATs (e.g., GNSS and cellular) to operate concurrently and satisfy all carrier requirements for portable computing devices.

### Example Computing Devices

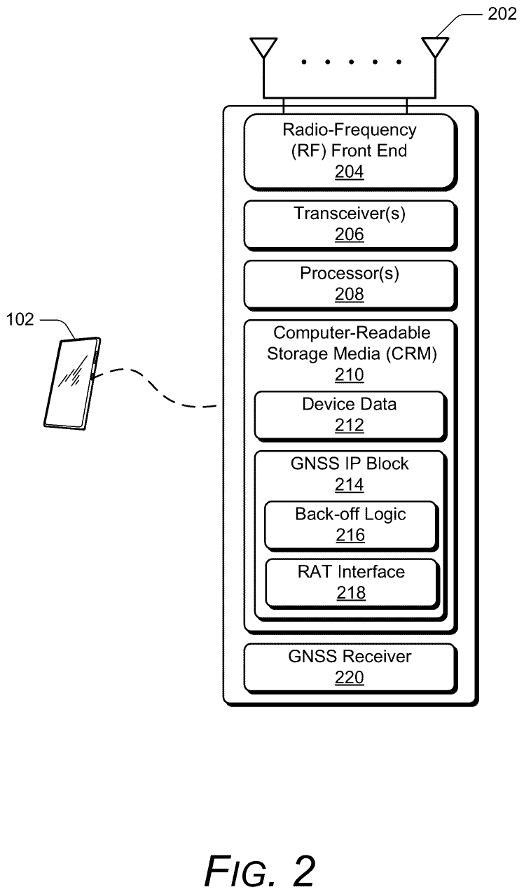

FIG. 2 illustrates an example computing device 102 capable of implementing adaptive wireless transmitter power control for GNSS interference mitigation. Although illustrated as a mobile phone (e.g., smartphone, user equipment (UE)), the computing device 102 may be any other computing device as described with respect to FIG. 1.

The computing device 102 may include additional functions and interfaces that are omitted from FIG. 2 for the sake of clarity. In the depicted configuration, the computing device 102 includes antennas 202, an RF front end 204, one or more RF transceivers 206 (e.g., Wi-Fi/Bluetooth transceiver, cellular transceiver 120, etc.), and the GNSS receiver 220. The RF front end 204 couples or connects the one or more RF transceivers 206 or GNSS receiver 220 to the antennas 202 to facilitate various types of wireless communication. The antennas 202 can include an array of multiple antennas that are configured similar to or differently from each other. The antennas 202 and the RF front end 204 are tuned to one or more transmission frequency bands defined by the various communications protocols utilized by the RAT subsystems or the GNSS subsystem.

The computing device 102 also includes one or more processors 208 and memory system, including, for example, computer-readable storage media 210 (CRM 210). The processor 208 can be a single-core processor or a multiple-core processor composed of a variety of materials, such as silicon, polysilicon, high-K dielectric, copper, and so on. The CRM 210 may exclude propagating signals and includes any suitable memory or storage device, such as random-access memory (RAM), static RAM (SRAM), dynamic RAM (DRAM), non-volatile RAM (NVRAM), read-only memory (ROM), or Flash memory useable to store device data 212 of the computing device 102. The device data 212 includes user data, multimedia data, beamforming codebooks, applications, and/or an operating system of the computing device 102, which are executable by the processor 208 to enable the computing device 102 to perform various wireless communications and enable user interaction with the computing system 102.

The CRM 210 also includes a GNSS IP block 214 that can control various power back-off requests to the various RAT subsystems of the computing device 102. Alternatively or additionally, the GNSS IP block 214 can be implemented in whole or part as hardware logic or circuitry integrated with or separate from other components of the computing device 102. The GNSS IP block 214 may be configured to determine characteristics of certain GNSS operations (e.g., tracking operations) performed by the GNSS subsystem. For example, the GNSS IP block 214 may include back-off logic 216 that is configured to determine when a GNSS subsystem, or the operations thereof, are in an idle state or an active state. The back-off logic 216 may operate in accordance with different modes, for example, an acquisition state and a tracking mode.

In the acquisition state, the back-off logic 216 may assert power back-off requests through the RAT interfaces 218 to reduce interference in bands utilized by the GNSS subsystem. For example, a power back-off request may be asserted to one or more RAT subsystems that transmit or receive signals that interfere with the current GNSS operations. Once an acquisition has occurred and the GNSS has determined a position/time solution, the power back-off logic may determine if the location request was a single request or if continuous location determinations are needed.

If continuous location determinations are needed, the back-off logic 216 may operate in accordance with a tracking mode. In the tracking mode, the GNSS subsystem may perform tracking operations through full tracking or duty-cycle tracking. In full tracking, the GNSS may constantly operate in the active state until the tracking requests are deasserted. In duty-cycle tracking, however, the GNSS may spend portions of time in the active state while transitioning to the idle state during other time periods. In this way, the GNSS may only actively receive satellite signals in the active state, and at other times, conserve power in the idle state.

The back-off logic 216 may also determine signal qualities associated with satellite signals received by the GNSS that enable position/time solutions. If the back-off logic 216 determines that the GNSS is in an active state and that the satellite signals received by the GNSS subsystem do not meet certain quality standards, the back-off logic 216 may assert power back-off requests that are effective to reduce the power of one or more RAT transmitters that cause interference with the GNSS signals. The back-off logic 216 may assert power back-off requests through one or more RAT interfaces 218 that connect the GNSS or the GNSS IP block 214 to the RAT subsystems. The power back-off requests may be implemented as signaling or interrupts to individual hardware pins associated with RAT subsystems or as software messages to the RAT subsystems.

If it is determined that the GNSS subsystem is in the idle state or that the satellite signal qualities satisfy the necessary quality standard, the back-off logic 216 may deassert the power back-off requests through the RAT interface 218 to allow the various RAT subsystems to recover from previous power back-offs and interrupts.

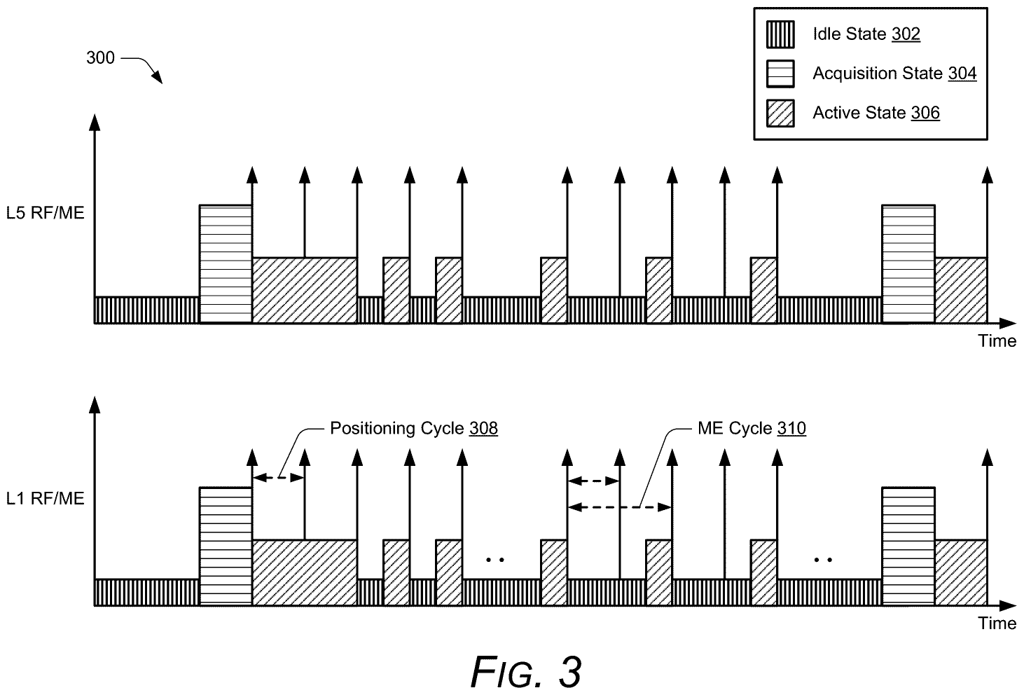

In some implementations, state and signal quality determinations may be made on a per-constellation or per-band basis. In this way, the back-off logic 216 may assert power back-off requests only on RAT transmitters that utilize specific bands or specific constellations. Moreover, the back-off logic 216 may be specific to each constellation or band to allow for optimized interference mitigation of each constellation or band. In general, the GNSS IP block 214 can, at least partially, assert and deassert power back-off requests to mitigate multi-transmitter interference as described with respect to FIGS. 3-10.

FIG. 3 illustrates an example timing diagram 300 for GNSS subsystem duty-cycle tracking. As illustrated, FIG. 3 demonstrates a dual-band operation of GNSS tracking on the L5 band (illustrated at top) and L1 band (illustrated at bottom). The GNSS subsystem is illustrated in three states: an idle state 302, an acquisition state 304, and an active state 306. A position cycle 308 that signifies a location request to the GNSS subsystem and a measurement cycle 310 that signifies the determination of an updated position/time solution by the GNSS subsystem is also illustrated. As non-limiting examples, the position cycle 308 may assert a position request every one second and the measurement cycle 310 may be implemented as two seconds.

In the idle state 302, the GNSS subsystem may not receive satellite signals to determine position/time solutions. Instead, the GNSS subsystem may maintain the previous position/time solution determined. If a position request is asserted while the GNSS is in the idle state 302, the GNSS subsystem may return the most recent position/time solution determined. In the idle state 302, the GNSS subsystem may not receive satellite signals for position/time solutions. As such, the power back-off requests may be deasserted, as it may not be important to mitigate GNSS signal interference.

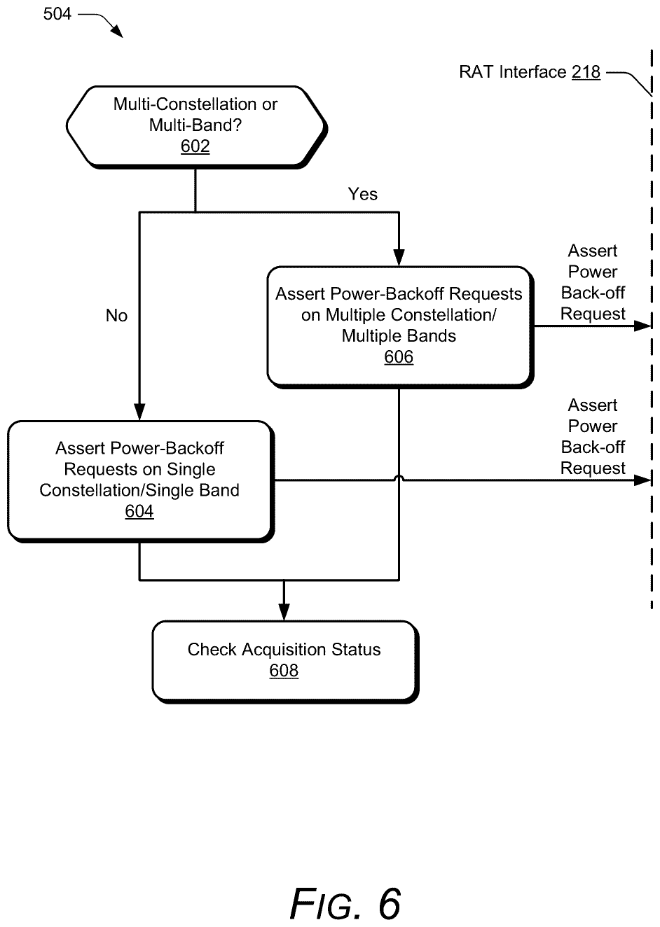

In the acquisition state 304, the GNSS subsystem may attempt to acquire appropriate satellites to determine a position/time solution. In the acquisition state 304, the GNSS subsystem may assert power back-off requests to one or more constellations/bands utilized to receive satellite signals. In some implementations, power back-off requests may be asserted to each RAT transmitter that utilizes a same band as a current GNSS operation. In the illustrated example, power back-off requests may be asserted to RAT transmitters that utilize the L1 or L5 bands. The GNSS subsystem may monitor the acquisition of the appropriate satellites, and when a position/time solution is determined, switch into a tracking mode. The acquisition state is described in greater detail with respect to FIG. 6.

In the tracking mode, the GNSS subsystem may operate in the active state 306 or in the idle state 302. In the active state 306, the GNSS subsystem may actively receive satellite signals that are usable to determine position/time solutions. In some implementations, the GNSS subsystem may operate in the active state any time that location requests are asserted (e.g., full tracking). In other implementations, the GNSS subsystem may spend portions of the time in the idle state 302 and portions of the time in the active state 306 when location requests are asserted (e.g., duty-cycle tracking). In this way, other RATs (e.g., cellular) may intermittently operate without power back-off requests and interrupts.

In the active state 306, the GNSS subsystem may determine whether power back-off requests are necessary. For example, the GNSS subsystem may determine that a set of qualities associated with received satellite signals do not satisfy a signal quality threshold. As a result, the GNSS subsystem may assert power back-off requests to mitigate GNSS signal interference and improve signal quality.

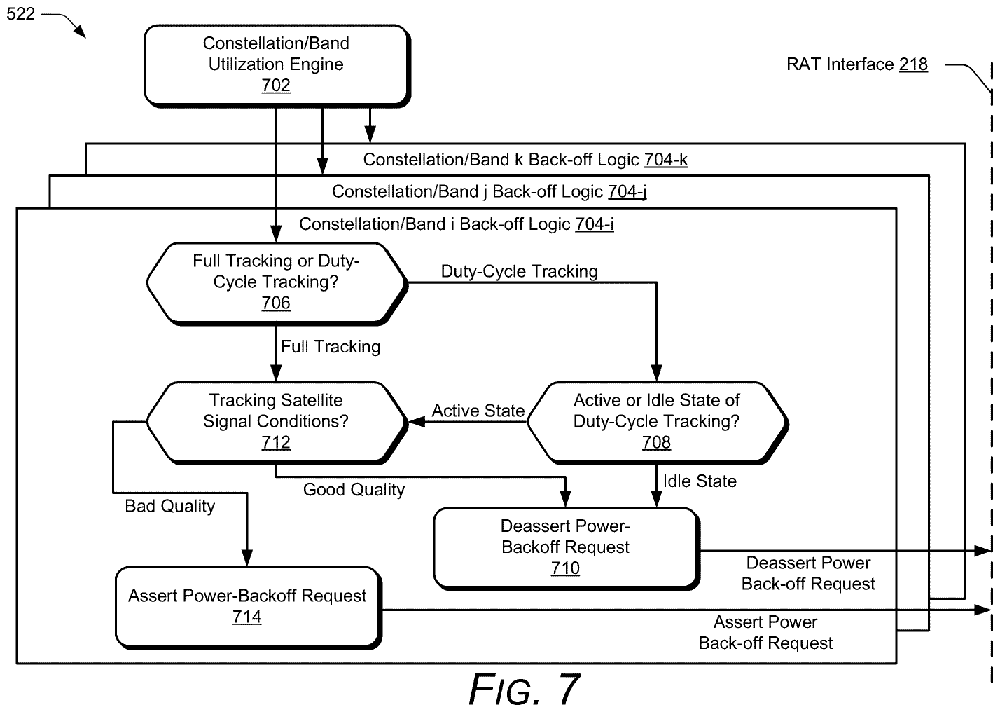

At other times, the GNSS subsystem may determine that a set of qualities associated with received satellite signals does satisfy signal quality threshold. In this case, the GNSS subsystem may deassert power back-off requests to loosen power requirements on other RAT transmitters and enable better performance of the non-GNSS RAT subsystems. In some implementations, power back-off requests may be asserted and deasserted on a per-constellation or per-band basis, as described with respect to the tracking mode of FIG. 7.

Once location requests have terminated, the tracking mode may be exited, and the GNSS may be turned off. If another location request is received at the GNSS, the process may begin again at the acquisition state to determine a position/time solution.

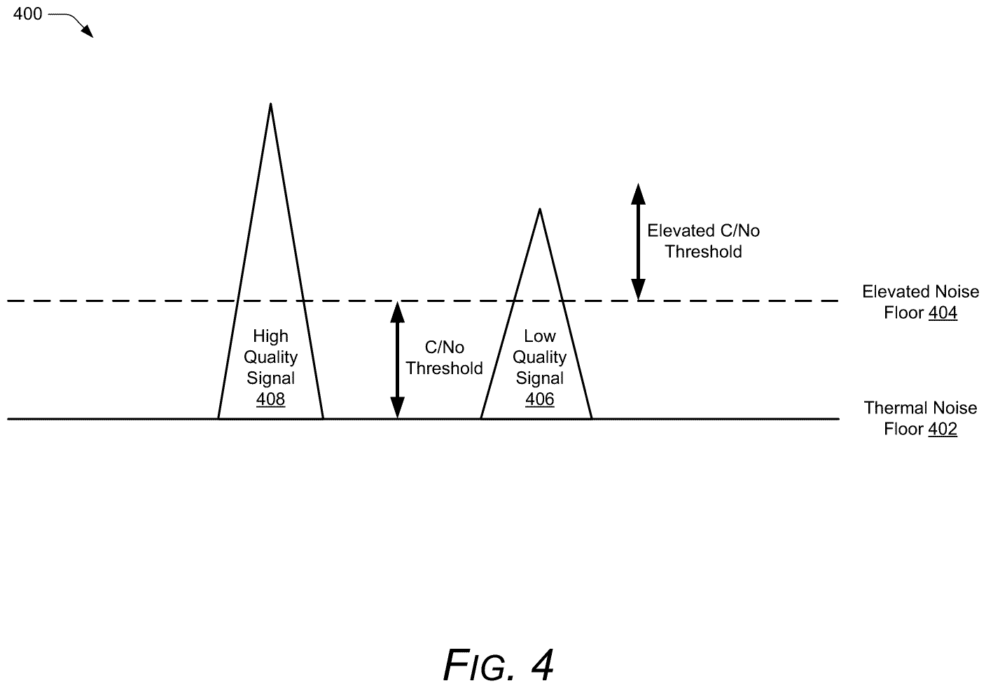

FIG. 4 illustrates an example of a signal quality determinations in accordance with one or more aspects of adaptive wireless transmitter power control for GNSS interference mitigation. In the tracking mode, power back-off requests may be asserted or deasserted based on signal qualities of received satellite signals. For example, power back-off requests may be controlled based on determinations of whether satellite receive-signal qualities satisfy a signal quality threshold.

In some implementations, a signal-to-noise ratio (carrier to noise ratio (C/No)) can be used to determine the quality of satellite receive signals. For example, signal quality may be measured based on the prevalence of the carrier signal with reference to system noise. For some operations, a minimum signal-to-noise ratio may be required to ensure proper performance. Without signal interference or other noise additions, a signal strength may be measured based on the thermal noise floor 402 (e.g., −174 dBm/Hz). When other signals create interference, however, the noise floor may increase as demonstrated by the elevated noise floor 404. As such, previously strong signals that met the minimum signal-to-noise threshold may fail to satisfy the minimum elevated signal-to-noise threshold due to signal interference, as shown by the low-quality signal 406. In terms of signal quality determinations in the tracking mode, the low-quality signal 406 may be determined not to meet the signal quality threshold based on the signal-to-noise ratio. As a result, the GNSS subsystem may assert power back-off requests to one or more RAT transmitter suspected to cause signal interference.

The high-quality signal 408, however, is shown to satisfy the elevated signal-to-noise threshold. Due to the quality of the high-quality signal, the GNSS subsystem may determine that one or more power back-off requests may be deasserted to reduce the restrictions on various RAT transmitters and enable improved performance of the RAT subsystems.

It is important to note that this is but one implementation usable to determine signal quality. In other implementations, different signal characteristics may be used to determine signal quality. For example, a measurement engine of the GNSS subsystem (e.g., ME/DSP 112) may determine characteristics of received radar signals (e.g., cross-correlation) or receiver response to signal reception (e.g., automatic gain control (AGC)). When a measurement engine measures a low AGC, signal reception from a satellite may have been aborted due to high cross-correlation. In this case, there may be a high amount of signal interference in the GNSS operation. Due to this relationship, AGC or cross-correlation may be used as a measure of signal quality. For example, when the AGC is measured below a predetermined level, the signal may be determined as a low-quality signal, and a power back-off request may be asserted to one or more RAT transmitters to reduce signal interference.

### Example Methods

Methods are illustrated as a set of blocks that specify operations that may be performed but are not necessarily limited to the order or combinations shown for performing the operations by the respective blocks. Further, any of one or more of the operations may be repeated, combined, reorganized, skipped, or linked to provide a wide array of additional and/or alternate methods. Each of these methods may operate alone or in conjunction with others, in whole or in part. The techniques are not limited to performance by one entity or multiple entities operating on one device. For clarity, the method is described with reference to the elements of FIGS. 1 through 4.

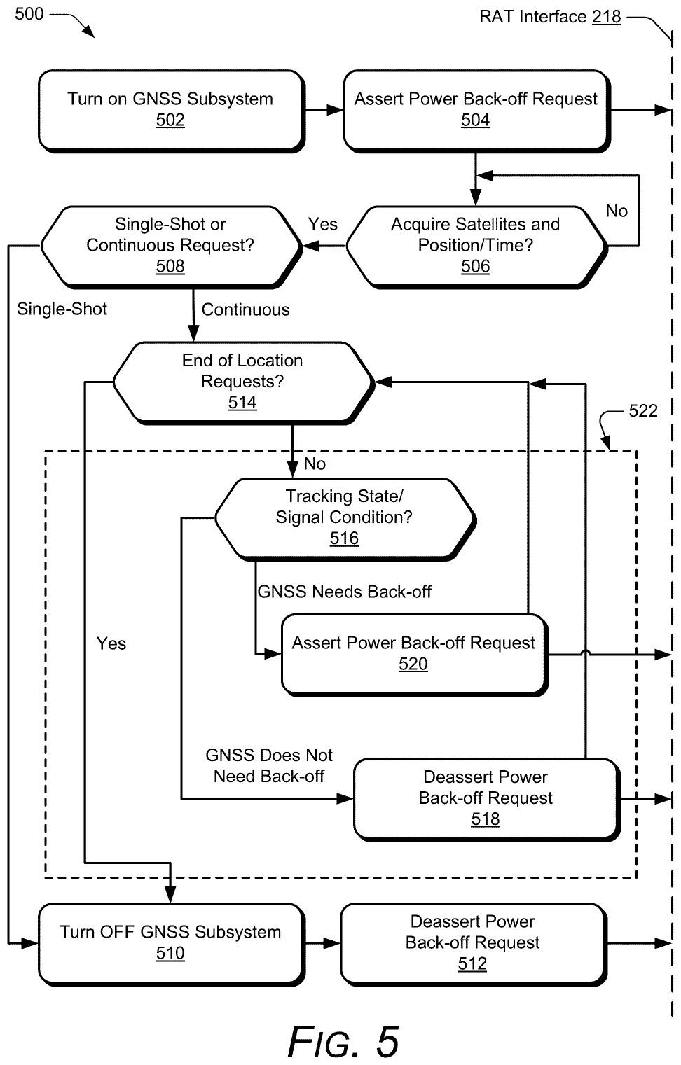

FIG. 5 illustrates an example method 500 for performing one or more aspect of adaptive wireless transmitter power control for GNSS interference mitigation. In aspects, the method 500 may be performed by a GNSS IP block 214 that is internal or external to the GNSS chip 104.

Based on the GNSS signal conditions or multi-band waveform measurement availability and fidelity, the GNSS IP block 214 may send hardware interrupts or software messages to other wireless RAT chips/IP blocks to indicate the transmitting power back-off or recover requests. Once another wireless RAT receives the requests from the GNSS subsystem, it can apply its own transmitting power control logic to back-off the transmit (Tx) power at a certain frequency band/channel or their combinations, or further blocklist a certain frequency band/channel in frequency-hopping systems, such as Bluetooth R.

At 502, the GNSS subsystem hardware is turned on responsive to a location request asserted by a network framework (e.g., Android, IOS) and top-level applications, context hub runtime environment (CHRE) framework and top-level nano-applications, or E911 Network (e.g., emergency service). When the GNSS subsystem hardware is turned on, the GNSS IP block 214 can assert corresponding power back-off interrupts to wireless RATs at 504. Power back-off requests may be asserted through the RAT interface 218 which connects the GNSS IP block 214 to the one or more wireless RAT subsystems. In general, the operations at 504 are controlled in accordance with the acquisition state 304 for a single-constellation/band acquisition system or multi-constellation/band acquisition system, which is described in greater detail with respect to FIG. 6.

Furthermore, wireless RAT subsystems may listen to these interrupts from the GNSS subsystem and adjust transmit power based on a respective transmit-power-control algorithm/process. For example, based on the look-up table and power control requests from a base station, cellular subsystems can decide whether or not to apply the power back-off for particular frequency bands, as requested by the GNSS subsystem interrupts. If the RAT subsystem decides to apply power back-off, it can apply the power back-off value based on look-up tables and other power control requests.

At 506, The GNSS IP block 214 can continue to monitor the satellite acquisition states and position/time fix indicator. If the GNSS subsystem is still in the acquisition state 304 and has not determined a position/time solution, the GNSS IP block 214 can keep asserting the power back-off requests. If the GNSS subsystem has determined a position/time solution, the GNSS IP block may continue at 508 where the nature of the location request is determined. If the location request is single-shot, the GNSS subsystem may provide the position/time solution info to the location-request clients, and then turn off the GNSS RF block 108 at 510. In such a case, the GNSS IP block 214 can deassert the back-off requests to wireless RATs to indicate no more power back-off is needed from the GNSS subsystem.

If the location request is continuous, the GNSS subsystem may provide the position/time solution to the location request-clients periodically. In this case, the GNSS subsystem may enter the tracking mode. Based on the tracking mode state (full-tracking/duty-cycling, single-band/multi-band) and signal condition (C/No, cross-correlator output), the GNSS IP block 214 may assert/deassert the back-off requests to wireless RATs to indicate power back-off is needed/not needed from the GNSS subsystem. Specifically, at 514, the GNSS IP block 214 may determine if additional location requests to the GNSS have terminated. If location requests have terminated, the GNSS subsystem or the GNSS RF block 108 may be turned off at 510. If the location requests have not terminated (e.g., location requests are still asserted), however, the GNSS subsystem and the GNSS IP block 214 may continue to operate in accordance with the tracking mode.

At 516, the GNSS IP block 214 may determine if the GNSS subsystem is in the idle state 302 or the active state 306. In full tracking, the GNSS subsystem may continuously operate in the active state 306. In duty-cycle tracking, the GNSS subsystem may spend portions of time in the idle state 302 and other portions of time in the active state 306. In the idle state 302, the GNSS subsystem may not actively receive satellite signals to enable GNSS operations, thus power back-offs may not be necessary for RAT subsystems. In this case, the GNSS IP block 214 may deassert the power back-off requests at 518 through the RAT interface 218.

In the active state 306, however, power back-off request management may be controlled based on signal quality. For example, the GNSS IP block 214 may determine if a set of satellite receive-signals are high-quality signals 408 or low-quality signals 406. In aspects, signal quality may be determined from a number of characteristics, for example, signal-to-noise ratio, cross-correlator output, or automatic gain control. If it is determined that the set of signals are high-quality signals 408 (e.g., the signals satisfy a signal quality threshold), the GNSS IP block 214 may deassert the power back-off requests at 515 through the RAT interface 218 to enable other RAT subsystems to recover from previous power back-off interrupts. If it is determined that the set of signals are low-quality signals 406 (e.g., the signals do not satisfy a signal quality threshold), the GNSS IP block 214 may assert the power back-off requests at 520 through the RAT interface 218 to reduce the power of RAT transmitters and effectively reduce GNSS interference. Power back-off request assertion/deassertion in the tracking mode is illustrated within the method 522, which is further described with respect to FIG. 7.

FIG. 6 illustrates an example method 504 for asserting power back-off requests in an acquisition state 304 in accordance with one or more aspects of adaptive wireless transmitter power control for GNSS interference mitigation. The method 504 may be performed by the GNSS IP block 214.

At 602, the GNSS IP block 214 may determine if the GNSS subsystem uses multiple bands or multiple constellations to determine a position/time solution. If the GNSS subsystem uses a single-band/constellation for position/time solutions in the acquisition state 304, the techniques may assert a power back-off interrupt on a single interface of the RAT interface 218 (e.g., GPS/L1 or any other operating constellation/band) at 604.

If multiple bands or multiple constellations are used by the GNSS subsystem to determine a position/time solution in the acquisition state 304, the techniques may assert power back-off requests on one or more operating constellation (e.g., GPS, Galileo, GLONASS, Beidou, QZSS, NaviC), one or more operation band (e.g., L1, L5, L2, and so on), or on individual interfaces (e.g., corresponding hardware pin or software interrupt messages) at 606. In aspects, the individual interfaces are within the RAT interface 218. In the acquisition state 304, power back-off requests can be further expanded to multiple constellations, for example, GPS-L1 (1575.42 MHZ), GLONASS-G1 (1592.9525 MHz to 1610.485 MHZ), Beidou-Bli (1561.098 MHz). Each constellation with a different frequency can be assigned with individual back-off request signals, either hardware interrupts or software messages.

In either implementation, single-constellation/band tracking or multi-constellation/band tracking, the GNSS IP block 214 may check the acquisition status or position/time solution status of the GNSS subsystem at 608. In doing so, the GNSS IP block may continue to assert power back-off requests at least until a position/time solution is determined or the acquisition is successful. Once acquisition has been completed or the position/time solution is determined, the GNSS IP block and GNSS subsystem may continue operation as described in FIG. 5.

FIG. 7 illustrates an example method 522 for asserting/deasserting power back-off requests in a tracking mode in accordance with one or more aspects of adaptive wireless transmitter power control for GNSS interference mitigation. As discussed in FIG. 5, the method 522 may be performed by the GNSS IP block 214. In the tracking mode, the GNSS may determine to use multiple constellations (e.g., GPS/Galileo/GLONASS/Beidou/QZSS/Navic), or multi-bands (e.g, L1/L2/L5/E5a/E5b/B1c/B2c/Bli). The GNSS IP block 214 may utilize a constellation/band utilization engine 702 that determines active constellations/bands that are used for GNSS operations. Based on the active constellations/bands, an individual back-off process per constellation/band may be applied. In some implementations, the GNSS IP block 214 weighs the measurement results from each constellation/band, based on the auto-detected interference level, external system interrupts to the GNSS subsystem, or the visible constellation/waveform satellite number and dilution of precision. In this case, the techniques may apply the back-off process on heavy-weighted constellations/bands (e.g., that satisfy a weight threshold value).

For individual constellation/band power back-off processes in the tracking mode (e.g., constellation/band i back-off logic 704-i), the techniques may first check whether the GNSS subsystem is in full-tracking or duty-cycling tracking at 706. If the GNSS subsystem is in duty-cycling tracking, at 708 the GNSS IP block 214 may determine whether the GNSS subsystem is in the idle state 302 or the active state 306. If the GNSS subsystem is in the idle state 302 (e.g., the GNSS RF block 108 is off), then the techniques may deassert power back-off requests to other wireless RAT subsystems at 710 through the RAT interface 218.

If, however, at 708 the GNSS subsystem is in the active state 306 of duty-cycling tracking, or in full-tracking, then the GNSS IP block 214 may check the satellite signal conditions to determine whether to assert/deassert the power back-off request at 712. Furthermore, if the satellite signal conditions are good (e.g., they satisfy a signal quality threshold), for example, a high carrier-to-noise ratio (C/No) or/and a low cross-correlator output in the existing measurement engine, then the techniques may deassert the power back-off requests to other wireless RAT at 710 through the RAT interface 218. If the satellite signal conditions are bad (e.g., they do not satisfy a signal quality threshold), for example, low C/No or/and high cross-correlator output, then the GNSS IP block 214 may assert power back-off requests at 714 through the RAT interface 218.

In aspects, the GNSS IP block 214 may assert/deassert power back-off requests on a per-constellation or per-band basis. For example, through the constellation/band i back-off logic 704-i, the GNSS IP block 214 may assert power back-off requests to RAT transmitters that operate on constellation/band i. Other constellations or bands may assert/deassert power back-off requests in accordance with respective constellation/band back-off logic (e.g., constellation/band j back-off logic 704-j and constellation/band k back-off logic 704-k). In some implementations, one or more constellation/bands may assert/deassert power back-off requests simultaneously.

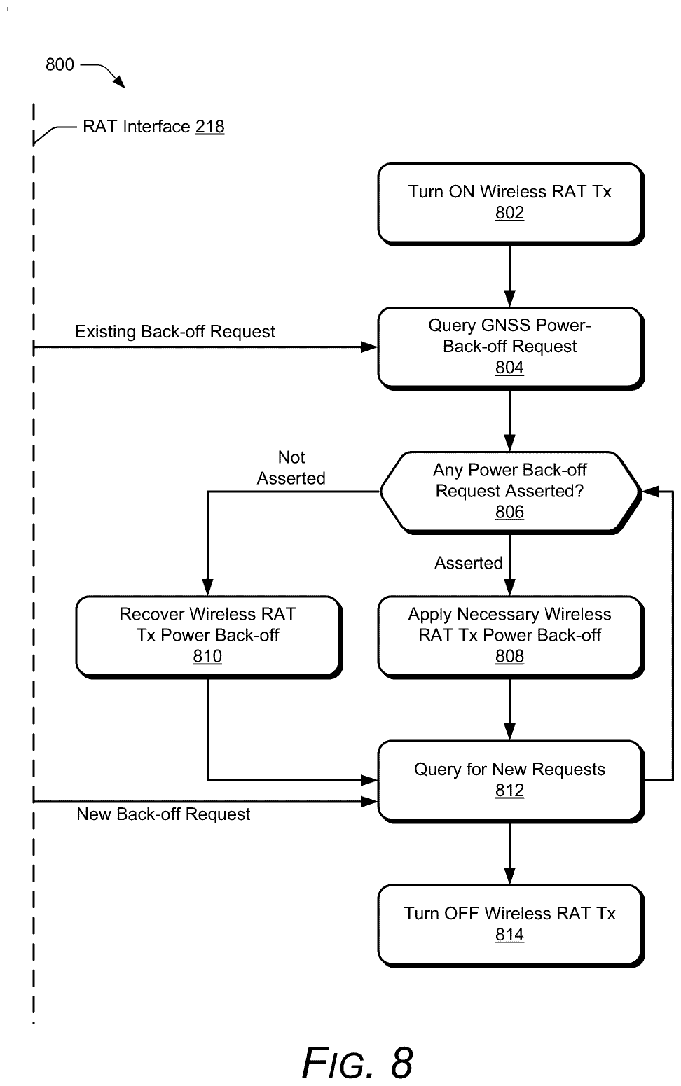

FIG. 8 illustrates an example method 800 for implementing a RAT in accordance with one or more aspects of adaptive wireless transmitter power control for GNSS interference mitigation. In aspects, the method 800 illustrates a RAT system transmit power control (TPC) algorithm/process as performed by an internal or external power controller of the RAT subsystem. The method 800 illustrates an example of how a power back-off request is received through the RAT interface 218 as a result of adaptive wireless transmitter power control for GNSS interference mitigation, as described in FIG. 5.

At 802, a wireless RAT transmitter (e.g., within the Wi-Fi/Bluetooth SoC 118 or cellular transceiver 120) is turned on. At 804, the RAT subsystem may query for any power back-off requests through the RAT interface 218 (e.g., from the hardware pin or software message cached in the memory). At 806, the RAT subsystem may determine whether any power back-off requests have been asserted based on the query to the RAT interface 218 at 804. If a power back-off request is asserted, it may combine with other TPC inputs and state machines, to determine whether or not Tx back-off will be applied, and if so, how much Tx back-off will be applied to respective RAT transmitting antennas, bands, channels, etc. For example, it will look up the preset maximum transmit power level (MTPL) back-off table for a particular antenna/band and get the MTPL offset power. Based on the base station power control request and the MTPL offset, the RAT subsystem may adjust the transmit power to make sure it will not be higher than the power threshold for proper GNSS operation at 808.

If a power back-off request is not asserted, at 810 the RAT subsystem may not apply any power control and may attempt to recover from previous power back-off requests. At 812, the RAT subsystem may keep listening for power back-off requests across the RAT interface 218. If a power back-off request is asserted/deasserted, the process may continue at 806 in accordance with the TPC algorithm. The RAT subsystem may follow this process until the RAT subsystem terminates operation at 814.

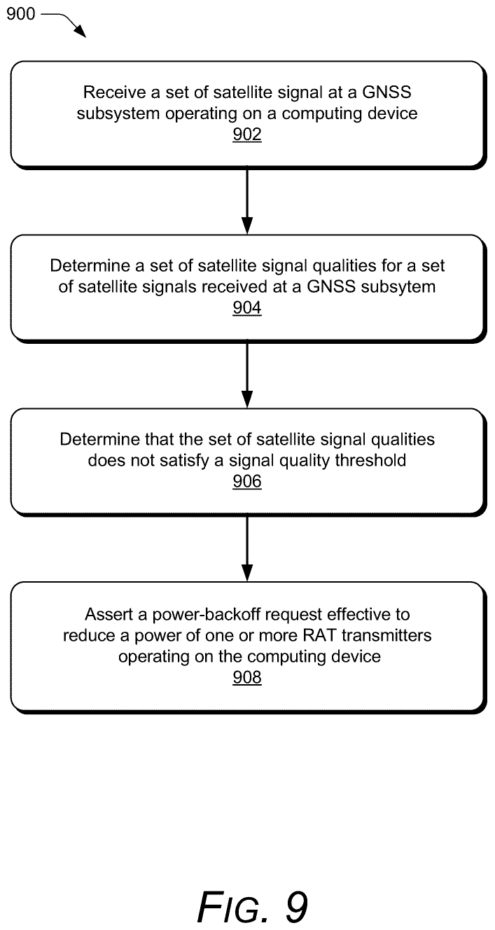

FIG. 9 illustrates an example method 900 for asserting a power back-off request based on signal quality. At 902, a set of satellite signals are received at a GNSS subsystem operating on the computing device 102. The set of satellite signals may be usable to perform a tracking operation of the GNSS subsystem. In aspects, the set of satellite receive signals may include interference from one or more RAT transmitters operating on the computing device 102.

At 904, a set of satellite signal qualities are determined for the set of satellite signals received at a GNSS. The satellite signal qualities may be determined by a measurement engine or digital signal processor 112 of the GNSS. The set of satellite signals may correspond to a number of satellite signals received through one or more bands or constellations that enable a GNSS subsystem operation. The signal qualities may include any number of signal characteristics, including but not limited to signal-to-noise ratio or cross-correlator output.

At 906, the GNSS IP block 214 determines that the set of satellite signal qualities does not satisfy a signal quality threshold. In aspects, the signal quality threshold may include a minimum signal-to-noise ratio or maximum cross-correlator output. The set of satellite signals may be determined not to satisfy the signal quality threshold due to GNSS interference from other transmitters.

At 908, the GNSS IP block 214 may assert a power back-off request effective to reduce a power of one or more RAT transmitters operating on the computing device. The power back-off requests may be asserted on a per-constellation or per-bank basis such that signal interference is reduced at a particular constellation or band. In aspects, the power back-off request is asserted in response to determining that the set of satellite signal qualities does not satisfy a signal quality threshold.

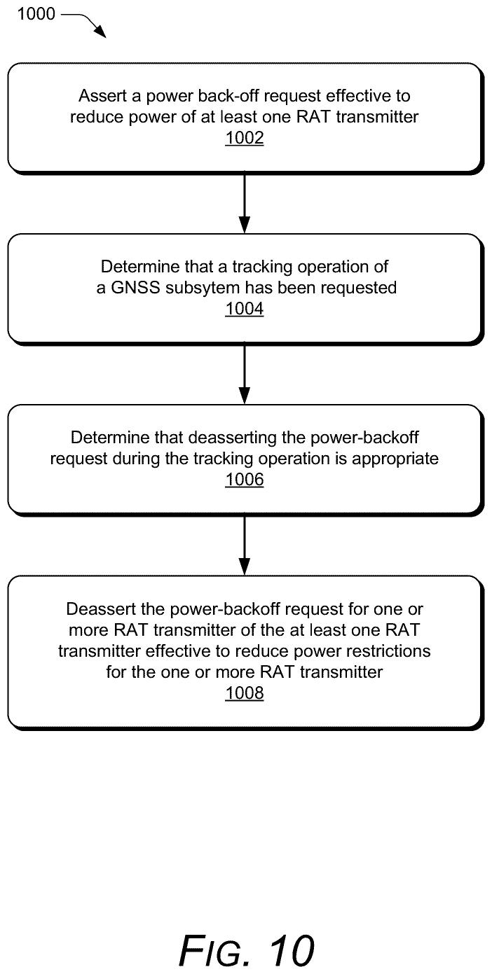

FIG. 10 illustrates an example method for deasserting a power back-off request in accordance with one or more aspects of adaptive wireless transmitter power control for GNSS interference mitigation. At 1002, a power back-off request is asserted effective to reduce power of at least one RAT transmitter. In aspects, the power back-off request may be asserted in accordance with the acquisition state 304. For example, the power back-off request may be asserted in a single constellation/band or multiple constellations/bands until the acquisition process is completed and a position/time solution is determined.

At 1004, it is determined that a tracking operation of the GNSS subsystem has been requested. For example, the GNSS IP block 214 may determine that the location request to the GNSS subsystem is a continuous location request and that tracking is needed. A tracking request may be asserted until position/time solutions are no longer needed. If a tracking operation of the GNSS subsystem has been requested, the GNSS subsystem or the GNSS IP block 214 may operate in accordance with a tracking mode.

At 1006, the GNSS IP block 214 determines that it is appropriate to deassert the power back-off request during the tracking operation. For example, the GNSS IP block 214 may determine that the GNSS subsystem is currently in the idle state 302, and thus the power back-off request may be deasserted. In other examples, the GNSS IP block 214 may determine that it is appropriate to deassert the power back-off request because satellite signal qualities of a set of satellite signals received by the GNSS subsystem satisfy a signal quality threshold.

At 1008, the power back-off request is deasserted for one or more RAT transmitter effective to reduce power restriction for the one or more RAT transmitter. In aspects, the GNSS IP block 214 may deassert power back-off requests on a per-constellation or per-bank basis. For example, the GNSS IP block 214 may deassert power back-off requests such that power restrictions are reduced for one or more RAT transmitter operating on a particular band. In aspects, the power back-off request is deasserted in response to determining that it is appropriate to deassert the power back-off request during the tracking operation.

### Additional Examples

Examples of adaptive wireless transmitter power control for GNSS interference mitigation are described below:

Example 1: A method of mitigating interference to global navigation satellite system, GNSS, subsystem signals by a computing device, the method comprising: receiving, at the GNSS subsystem operating on the computing device, a first set of satellite signals; determining a first set of satellite signal qualities for the first set of satellite signals received at the GNSS subsystem operating on the computing device; determining that the first set of satellite signal qualities does not satisfy a signal quality threshold; and responsive to determining that the first set of satellite signal qualities does not satisfy the signal quality threshold, asserting, by the GNSS subsystem, a power back-off request effective to reduce a power of one or more radio access technology, RAT, transmitters operating on the computing device.

Example 2: The method as recited by any of the previous examples, wherein: the set of satellite signals is received from a first constellation or in a first radio-frequency band; and asserting the power back-off request is effective to reduce the power of the one or more RAT transmitters for the first radio-frequency band.

Example 3: The method as recited by any of the previous examples, further comprising: determining a second set of satellite signal qualities for a second set of satellite signals received at the GNSS subsystem operating on the computing device and from a second constellation or a second radio-frequency band that is different than the first constellation or the first radio-frequency band; determining that the second set of satellite signal qualities does not satisfy the signal quality threshold; and responsive to determining that the second set of satellite signal qualities does not satisfy the signal quality threshold, asserting, by the GNSS subsystem, a power back-off request effective to reduce a power of one or more RAT transmitters operating on the computing device for the second radio-frequency band.

Example 4: The method as recited by any of the previous examples, further comprising determining that a weighting of the first constellation or the first radio frequency band satisfies a weight threshold value, wherein determining the first set of satellite signal qualities for the first set of satellite signals received from the first constellation or the first radio-frequency band is responsive to determining that the weighting of the first constellation or the first radio-frequency band satisfies a weight threshold value.

Example 5: The method as recited by any of the previous examples, the weighting of the first constellation or the first radio-frequency band is based on at least one of: an interference level of the first constellation or the first radio-frequency band; or a number of external system interrupts to the GNSS subsystem at the first constellation or the first radio-frequency band.

Example 6: The method as recited by any of the previous examples, further comprising determining that a tracking operation is active for the GNSS subsystem operating on the computing device, wherein determining the first set of satellite signal qualities is responsive to determining that the tracking operation is active for the GNSS subsystem operating on the computing device.

Example 7: The method as recited by any of the previous examples, further comprising: asserting, by the GNSS subsystem, an initial power back-off request effective to reduce a power of one or more RAT transmitters operating on the computing device; determining that a position or time is acquired by the GNSS subsystem; and determining that an additional position or time acquisition by the GNSS subsystem is requested, wherein determining the first set of satellite signal qualities is responsive to determining that the additional position or time acquisition by the GNSS subsystem is requested.

Example 8: The method as recited by any of the previous examples, further comprising determining that the GNSS subsystem operating on the computing device is using multi-band or multi-constellation acquisition, wherein the initial power back-off request comprises a request to reduce a power of one or more RAT transmitters operating on the computing device at any constellation or radio-frequency band available to the multi-band or multi-constellation acquisition.

Example 9: The method as recited by any of the previous examples, further comprising determining that the GNSS subsystem operating on the computing device is using single-band or single-constellation acquisition, wherein the initial power back-off request comprises a request to reduce a power of one or more RATs operating on the computing device at a particular constellation or a particular radio-frequency band available to the single-band or single-constellation acquisition.

Example 10: A method of mitigating interference to global navigation satellite system, GNSS, subsystem signals by the computing device, the method comprising: asserting, by the GNSS subsystem, a power back-off request effective to reduce power of at least one radio access technology, RAT, transmitter operating on a computing device; determining that a tracking operation of the GNSS subsystem operating on the computing device has been requested; determining that deasserting the power back-off request during the tracking operation is appropriate; and responsive to determining that deasserting the power back-off request during the tracking operation is appropriate, deasserting, by the GNSS subsystem, the power back-off request for one or more RAT transmitters of the at least one RAT transmitter effective to reduce power restrictions for the one or more RAT transmitters.

Example 11: The method as recited by any of the previous examples, wherein determining that deasserting the power back-off request during the tracking operation is appropriate comprises determining that the tracking operation is in an idle state.

Example 12: The method as recited by any of the previous examples, wherein determining that deasserting the power back-off request for the GNSS subsystem during the tracking operation is appropriate comprises determining that a set of satellite signals received at the GNSS subsystem useable to perform the tracking operation satisfies a signal quality threshold.

Example 13: The method as recited by any of the previous examples, wherein: the tracking operation of the GNSS subsystem utilizes a first constellation or a first radio-frequency band; and deasserting the power back-off request for the one or more RAT transmitters of the at least one RAT transmitter is effective to reduce power restrictions for the one or more RAT transmitters for the first constellation or the first radio-frequency band.

Example 14: The method as recited by any of the previous examples, wherein the tracking operation is a first tracking operation and the method further comprises:
determining that a second tracking operation of the GNSS subsystem that utilizes a second constellation or a second radio-frequency band that is different than the first constellation or first radio-frequency band has been requested; determining that deasserting the power back-off request during the second tracking operation is appropriate; and responsive to determining that deasserting the power back-off request during the second tracking operation is appropriate, deasserting a power back-off request for the one or more RAT transmitters of the at least one RAT transmitter effective to reduce power restrictions for the one or more RAT transmitters at the second constellation or the second radio-frequency band.

Example 15: An apparatus comprising: a processor; and computer-readable storage media comprising instructions that, responsive to execution by the processor, direct the apparatus to perform a method as recited in any one of claims 1 to 14.

Example 16: A system comprising: a global navigation satellite system (GNSS); at least one radio access technology (RAT) transmitter; at least one processor; and one or more non-transitory computer-readable storage media that, when executed by the at least one processor, cause the at least one processor to: assert an initial power back-off request effective to reduce a power of the at least one RAT operating on a computing device; determine that a tracking operation of the GNSS has been requested; determine whether a power back-off request is appropriate during the tracking operation; and assert the power back-off request effective to reduce the power for the at least one RAT transmitter if determined that the power back-off request is appropriate during the tracking operation.

Example 17: The system as recited by any of the previous examples, wherein the one or more non-transitory computer-readable storage media, when executed by the at least one processor, cause the at least one processor to: deassert a power back-off request effective to reduce power restrictions for the at least one RAT transmitter if determined that the power back-off request is not appropriate during the tracking operation.

Example 18: The system as recited by any of the previous examples, wherein the one or more non-transitory computer-readable storage media, when executed by the at least one processor, cause the at least one processor to determine that the power back-off request is not appropriate during the tracking operation when the tracking operation is in an idle state or when a set of signals associated with the tracking operation and received at the GNSS satisfies a signal quality threshold.

Example 19: The system as recited by any of the previous examples, wherein the one or more non-transitory computer-readable storage media, when executed by the at least one processor, cause the at least one processor to determine that the power back-off request is appropriate during the tracking operation when a set of signals associated with the tracking operation and received at the GNSS does not satisfy a signal quality threshold.

Example 20: The system as recited by any of the previous examples, wherein: the tracking operation of the GNSS and the power back-off request are associated with a particular constellation or a particular radio-frequency band, and the one or more non-transitory computer-readable storage media, when executed by the at least one processor, cause the at least one processor to assert the power back-off request effective to reduce the power for the at least one RAT transmitter at the particular constellation or the particular radio-frequency band if determined that the power back-off request is appropriate during the tracking operation.

Example 21: The system as recited by any of the previous examples, wherein: the one or more non-transitory computer-readable storage media, when executed by the at least one processor, further cause the at least one processor to determine the one or more constellations or the one or more radio-frequency bands that will be used to acquire an initial position or time, wherein the initial power back-off request is effective to reduce the power of the at least one RAT at the one or more constellations or the one or more radio-frequency bands.

### Conclusion

Although concepts of techniques, apparatuses, and systems directed at adaptive wireless transmitter power control for GNSS interference mitigation have been described in language specific to techniques, apparatuses, and/or systems, it is to be understood that the subject of the appended claims is not necessarily limited to the specific techniques, apparatuses and systems described. Rather, the specific techniques, apparatuses, and systems are disclosed as example implementations of ways in which adaptive wireless transmitter power control for GNSS interference mitigation may be implemented.

1. A method comprising:
receiving, at the a global navigation satellite system (GNSS) subsystem operating on a computing device, a first set of satellite signals;
determining a first set of satellite signal qualities for the first set of satellite signals received at the GNSS subsystem operating on the computing device;
determining that the first set of satellite signal qualities does not satisfy a signal quality threshold; and
responsive to determining that the first set of satellite signal qualities does not satisfy the signal quality threshold, asserting, by the GNSS subsystem, a power back-off request effective to reduce a power of one or more radio access technology transmitters operating on the computing device.

2. The method of claim 1, wherein:
the set of satellite signals is received from a first constellation or in a first radio-frequency band; and
asserting the power back-off request is effective to reduce the power of the one or more radio access technology transmitters for the first radio-frequency band.

3. The method of claim 2, further comprising:
determining a second set of satellite signal qualities for a second set of satellite signals received at the GNSS subsystem operating on the computing device and from a second constellation or a second radio-frequency band that is different than the first constellation or the first radio-frequency band;
determining that the second set of satellite signal qualities does not satisfy the signal quality threshold; and
responsive to determining that the second set of satellite signal qualities does not satisfy the signal quality threshold, asserting, by the GNSS subsystem, a power back-off request effective to reduce a power of one or more radio access technology transmitters operating on the computing device for the second radio-frequency band.

4. The method of claim 2, further comprising determining that a weighting of the first constellation or the first radio-frequency band satisfies a weight threshold value, wherein determining the first set of satellite signal qualities for the first set of satellite signals received from the first constellation or the first radio-frequency band is responsive to determining that the weighting of the first constellation or the first radio-frequency band satisfies a weight threshold value.

5. The method of claim 4, wherein the weighting of the first constellation or the first radio-frequency band is based on at least one of:
an interference level of the first constellation or the first radio-frequency band; or
a number of external system interrupts to the GNSS subsystem at the first constellation or the first radio-frequency band.

6. The method of claim 1, further comprising determining that a tracking operation is active for the GNSS subsystem operating on the computing device, wherein determining the first set of satellite signal qualities is responsive to determining that the tracking operation is active for the GNSS subsystem operating on the computing device.

7. The method of claim 1, further comprising:
asserting, by the GNSS subsystem, an initial power back-off request effective to reduce a power of one or more radio access technology transmitters operating on the computing device;
determining that a position or time is acquired by the GNSS subsystem; and
determining that an additional position or time acquisition by the GNSS subsystem is requested, wherein determining the first set of satellite signal qualities is responsive to determining that the additional position or time acquisition by the GNSS subsystem is requested.

8. The method of claim 7, further comprising determining that the GNSS subsystem operating on the computing device is using multi-band or multi-constellation acquisition, wherein the initial power back-off request comprises a request to reduce a power of one or more radio access technology transmitters operating on the computing device at any constellation or radio-frequency band available to the multi-band or multi-constellation acquisition.

9. The method of claim 7, further comprising determining that the GNSS subsystem operating on the computing device is using single-band or single-constellation acquisition, wherein the initial power back-off request comprises a request to reduce a power of one or more radio access technology transmitters operating on the computing device at a particular constellation or a particular radio-frequency band available to the single-band or single-constellation acquisition.

10. A method comprising:
asserting, by a global navigation satellite system (GNSS) subsystem, a power back-off request effective to reduce power of at least one radio access technology transmitter operating on a computing device;
determining that a tracking operation of the GNSS subsystem operating on the computing device has been requested;
determining that deasserting the power back-off request during the tracking operation is appropriate; and
responsive to determining that deasserting the power back-off request during the tracking operation is appropriate, deasserting, by the GNSS subsystem, the power back-off request for one or more radio access technology transmitters of the at least one radio access technology transmitter effective to reduce power restrictions for the one or more radio access technology transmitters.

11. The method of claim 10, wherein determining that deasserting the power back-off request during the tracking operation is appropriate comprises determining that the tracking operation is in an idle state.

12. The method of claim 10, wherein determining that deasserting the power back-off request for the GNSS subsystem during the tracking operation is appropriate comprises determining that a set of satellite signals received at the GNSS subsystem useable to perform the tracking operation satisfies a signal quality threshold.

13. The method of claim 10, wherein:
the tracking operation of the GNSS subsystem utilizes a first constellation or a first radio-frequency band; and
deasserting the power back-off request for the one or more radio access technology transmitters of the at least one radio access technology transmitter is effective to reduce power restrictions for the one or more radio access technology transmitters for the first constellation or the first radio-frequency band.

14. The method of claim 13, wherein the tracking operation is a first tracking operation and the method further comprises:
determining that a second tracking operation of the GNSS subsystem that utilizes a second constellation or a second radio-frequency band that is different than the first constellation or first radio-frequency band has been requested;
determining that deasserting the power back-off request during the second tracking operation is appropriate; and
responsive to determining that deasserting the power back-off request during the second tracking operation is appropriate, deasserting a power back-off request for the one or more radio access technology transmitters of the at least one radio access technology transmitter effective to reduce power restrictions for the one or more radio access technology transmitters at the second constellation or the second radio-frequency band.

15. (canceled)

16. A computing device comprising:
one or more radio access technology transmitters;
a global navigation satellite system (GNSS) subsystem;
at least one processor; and
computer-readable storage media comprising instructions that, responsive to execution by the at least one processor, cause the at least one processor to:
assert, by the GNSS subsystem, a power back-off request effective to reduce power of at least one radio access technology, RAT, transmitter operating on the computing device;
determine that a tracking operation of the GNSS subsystem operating on the computing device has been requested;
determine that deasserting the power back-off request during the tracking operation is appropriate; and
responsive to the determination that deasserting the power back-off request during the tracking operation is appropriate, deassert, by the GNSS subsystem, the power back-off request for one or more radio access technology transmitters of the at least one radio access technology transmitter effective to reduce power restrictions for the one or more radio access technology transmitters.

17. The computing device of claim 16, wherein the determination that deasserting the power back-off request during the tracking operation is appropriate comprises a determination that the tracking operation is in an idle state.

18. The computing device of claim 16, wherein the determination that deasserting the power back-off request for the GNSS subsystem during the tracking operation is appropriate comprises a determination that a set of satellite signals received at the GNSS subsystem useable to perform the tracking operation satisfies a signal quality threshold.

19. The computing device of claim 18, wherein:
the tracking operation of the GNSS subsystem utilizes a first constellation or a first radio-frequency band; and
deassertion of the power back-off request for the one or more radio access technology transmitters of the at least one radio access technology transmitter is effective to reduce power restrictions for the one or more radio access technology transmitters for the first constellation or the first radio-frequency band.

20. The computing device of claim 19, wherein the tracking operation is a first tracking operation, and wherein the computer-readable storage media comprises instructions that further cause the at least one processor to:
determine that a second tracking operation of the GNSS subsystem that utilizes a second constellation or a second radio-frequency band that is different than the first constellation or first radio-frequency band has been requested; and
determine that deasserting the power back-off request during the second tracking operation is appropriate.

21. The computing device of claim 20, wherein:
responsive to the determination that deasserting the power back-off request during the second tracking operation is appropriate, deassert a power back-off request for the one or more radio access technology transmitters of the at least one radio access technology transmitter effective to reduce power restrictions for the one or more radio access technology transmitters at the second constellation or the second radio-frequency band.
